(19) United States
(12) Patent Application Publication
(10) Pub. No.: US 2025/0305645 A1
(43) Pub. Date: Oct. 2, 2025

(54) METHODS AND SYSTEMS FOR MODIFYING SMART GAS PIPELINE NETWORKS BASED ON REGULATORY INTERNET OF THINGS (IOT)

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Yaqiang QUAN, Chengdu (CN); Lei ZHANG, Chengdu (CN)

(73) Assignee: CHENGDU QINCHUAN IOT TECHNOLOGY CO., LTD., Chengdu (CN)

(21) Appl. No.: 19/235,566

(22) Filed: Jun. 11, 2025

(30) Foreign Application Priority Data
Apr. 16, 2025 (CN) 202510475660.3

(51) Int. Cl. F17D 5/00; F17D 5/02; G16Y 10/35; G16Y 40/10

(52) U.S. Cl. CPC F17D 5/005; F17D 5/02; G16Y 10/35; G16Y 40/10

(57) ABSTRACT

Some embodiments of the present disclosure provide a method and a system for modifying a smart gas pipeline network based on a regulatory Internet of Things (IoT). The method is executed by a gas company management platform of an IoT system for modifying a smart gas pipeline network. The method includes obtaining gas monitoring data from a smart gas device object platform through a gas company sensor network platform, obtaining historical fault data through the gas database, determining a modification strategy parameter based on the historical fault data and the gas monitoring data, generating a regulating instruction based on the modification strategy parameter, and sending the regulating instruction to the smart gas device object platform through the gas company sensor network platform to regulate a monitoring parameter of a gas monitoring device within the smart gas device object platform.

### CROSS-REFERENCE TO RELATED APPLICATIONS

This application claims priority to Chinese Patent Application No. 202510475660.3, filed on Apr. 16, 2025, the entire contents of which are hereby incorporated by reference.

### TECHNICAL FIELD

The present disclosure relates to the field of pipeline network modification, and in particular, to methods and systems for modifying smart gas pipeline networks based on a regulatory Internet of Things (IoT).

### BACKGROUND

With the increase in the service life of gas pipeline networks, in some aging residential communities where gas pipelines have been used for a long time, a portion of pipelines in the gas pipeline network presents problems such as aging facilities and frequent failures, thereby causing potential safety hazards. When transforming aging pipelines, the position of pipelines to be modified in the gas pipeline network and the modification manner need to be determined, so as to implement modification while ensuring the stable operation of the entire gas pipeline network.

Therefore, it is desired to provide a method and a system for modifying a smart gas pipeline network based on a regulatory Internet of Things (IoT), for monitoring the service status of gas pipelines in real time and with high accuracy, so as to timely identify and effectively handle pipelines to be modified, thereby significantly improving the overall safety performance of the gas pipelines.

### SUMMARY

One or more embodiments of the present disclosure provide a method for modifying a smart gas pipeline network based on Internet of Things (IoT). The method may be executed by a gas company management platform of an IoT system for modifying a smart gas pipeline network. The method may include obtaining gas monitoring data from a smart gas device object platform through a gas company sensor network platform, and storing the gas monitoring data in a gas database; obtaining historical fault data through the gas database, determining a modification strategy parameter based on the historical fault data and the gas monitoring data, and uploading the modification strategy parameter to a smart gas government safety monitoring sensor network platform through a smart gas government safety monitoring management platform, where the modification strategy parameter includes at least one of data of pipelines to be modified and a construction parameter of the pipelines to be modified; and generating a regulating instruction based on the modification strategy parameter, and sending the regulating instruction to the smart gas device object platform through the gas company sensor network platform to regulate a monitoring parameter of a gas monitoring device within the smart gas device object platform.

One or more embodiments of the present disclosure provide an IoT system for modifying a smart gas pipeline network. The system may include a smart gas government safety monitoring management platform, a smart gas government safety monitoring sensor network platform, a smart gas government safety monitoring object platform, a gas company sensor network platform, a smart gas device object platform. The smart gas government safety monitoring object platform may include a gas company management platform. The gas company management platform may be configured to obtain gas monitoring data from the smart gas device object platform through the gas company sensor network platform, and store the gas monitoring data in a gas database; obtain historical fault data through the gas database, determine a modification strategy parameter based on the historical fault data and the gas monitoring data, and upload the modification strategy parameter to the smart gas government safety monitoring sensor network platform through the smart gas government safety monitoring management platform, where the modification strategy parameter includes at least one of data of pipelines to be modified and a construction parameter of the pipelines to be modified; and generate a regulating instruction based on the modification strategy parameter, and send the regulating instruction to the smart gas device object platform through the gas company sensor network platform to regulate a monitoring parameter of a gas monitoring device within the smart gas device object platform.

One or more embodiments of the present disclosure provide a non-transitory computer-readable storage medium. The storage medium may store one or more sets of computer instructions. When a computer reads the one or more sets of computer instructions in the storage medium, the computer may implement the method for modifying the smart gas pipeline network based on IoT.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and wherein:

FIG. 1 is a schematic diagram illustrating a platform structure of an IoT system for modifying a smart gas pipeline network according to some embodiments of the present disclosure;

FIG. 2 is a flowchart illustrating an exemplary process for modifying a smart gas pipeline network based on IoT according to some embodiments of the present disclosure;

FIG. 3 is a schematic diagram illustrating an exemplary evaluation model according to some embodiments of the present disclosure; and

FIG. 4 is a schematic diagram illustrating an exemplary impact estimation model according to some embodiments of the present disclosure.

### DETAILED DESCRIPTION

In order to more clearly describe the technical solutions of embodiments of the present disclosure, a brief introduction is provided below regarding the accompanying drawings required in the descriptions of the embodiments. The accompanying drawings do not represent all embodiments.

It should be understood that the terms “system,” “device,” “unit,” and/or “module” used herein are used as a way to distinguish different components, elements, parts, portions, or assemblies at different levels. If other terms can serve the same purpose, such terms may be used as alternatives.

Unless explicitly indicated otherwise in the context, the words “a,” “an,” and “the” are not intended to be limited to the singular form and may also include the plural form. In general, the terms “include” and “contain” are intended to indicate the inclusion of the explicitly identified steps or elements, and the steps or elements are not intended to constitute an exclusive listing. A process or device may also include other steps or elements.

In the embodiments of the present disclosure, when operations are described step-by-step, unless otherwise specified, an order of the operations may be interchangeable, one or more steps may be omitted, and other steps may be included during the operations.

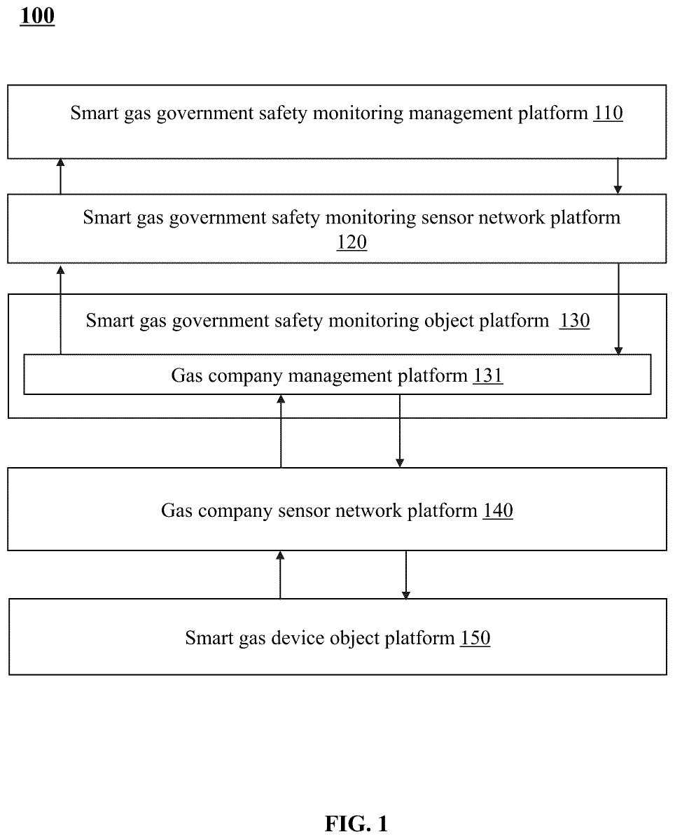

FIG. 1 is a schematic diagram illustrating a platform structure of an IoT system for modifying a smart gas pipeline network according to some embodiments of the present disclosure.

As shown in FIG. 1, an IoT system for modifying a smart gas pipeline network 100 (hereinafter referred to as the IoT system 100) may include a smart gas government safety monitoring management platform 110, a smart gas government safety monitoring sensor network platform 120, a smart gas government safety monitoring object platform 130, a gas company sensor network platform 140, a smart gas device object platform 150, and a gas user object platform 160.

The smart gas government safety monitoring management platform 110 refers to an integrated management platform for government management information.

In some embodiments, the smart gas government safety monitoring management platform 110 may interact with the smart gas government safety monitoring sensor network platform 120.

The smart gas government safety monitoring sensor network platform 120 refers to a platform for integrated management of government sensing information. The smart gas government safety monitoring sensor network platform 120 may be configured as a communication network, a gateway, or the like.

In some embodiments, the smart gas government safety monitoring sensor network platform 120 may interact with a gas company management platform 131. For example, the smart gas government safety monitoring sensor network platform 120 may obtain a modification strategy parameter uploaded by the gas company management platform 131.

The smart gas government safety monitoring object platform 130 refers to a platform for generating government supervision information and executing control information. In some embodiments, the smart gas government safety monitoring object platform 130 may include the gas company management platform 131.

The gas company management platform 131 refers to an integrated management platform for information of a gas company.

In some embodiments, the gas company management platform 131 may be configured to obtain gas monitoring data and store the gas monitoring data in a gas database, determine the modification strategy parameter based on historical fault data and the gas monitoring data, generate a regulating instruction based on the modification strategy parameter, and send the regulating instruction to the smart gas device object platform through the gas company sensor network platform to regulate a monitoring parameter of a gas monitoring device within the smart gas device object platform.

The gas database is configured to store information and/or data related to the IoT system 100. For example, the gas database may store the gas monitoring data, the historical fault data, historical monitoring data, or the like.

In some embodiments, the gas company management platform 131 may be configured to generate and send a leakage monitoring instruction, determine predicted monitoring data, predicted fault data, and a predicted evaluation parameter, generate and send a fault monitoring instruction, generate an indirect regulating instruction, and generate and send a monitoring expansion instruction.

The gas company sensor network platform 140 refers to a platform for the integrated management of sensing information of a gas company. In some embodiments, the gas company sensor network platform 140 may be configured as a communication network, a gateway, or the like. The gas company sensor network platform 140 may interact with the gas company management platform 131.

The smart gas device object platform 150 (hereinafter referred to as the device object platform 150) refers to a functional platform for generating sensing information and executing control information. In some embodiments, the device object platform 150 may interact with the gas company sensor network platform 140.

In some embodiments, the device object platform 150 may include gas monitoring devices and a crawling robot. The device object platform 150 may be communicatively and/or physically connected to the gas monitoring devices and the crawling robot, so as to control the gas monitoring devices and the crawling robot while acquiring data. The gas monitoring devices refer to devices for acquiring gas monitoring data. For example, the gas monitoring devices may include at least one of a gas flow velocity meter, a digital pressure gauge, a gas analyzer, a temperature sensor, or a humidity sensor arranged inside a gas pipeline, and at least one of a temperature sensor or a humidity sensor arranged outside the gas pipeline. The device object platform 150 may be wirelessly connected to the crawling robot.

In some embodiments, the IoT system 100 may further include a server. Each platform may be disposed on the server and communicatively connected through a network. The server may process information and/or data related to the IoT system 100 to execute one or more functions described in the present disclosure. In some embodiments, the server may include a processor, a memory, a storage device, and a network. The storage device may store the gas database. The gas database refers to a database management system supporting high-concurrency access.

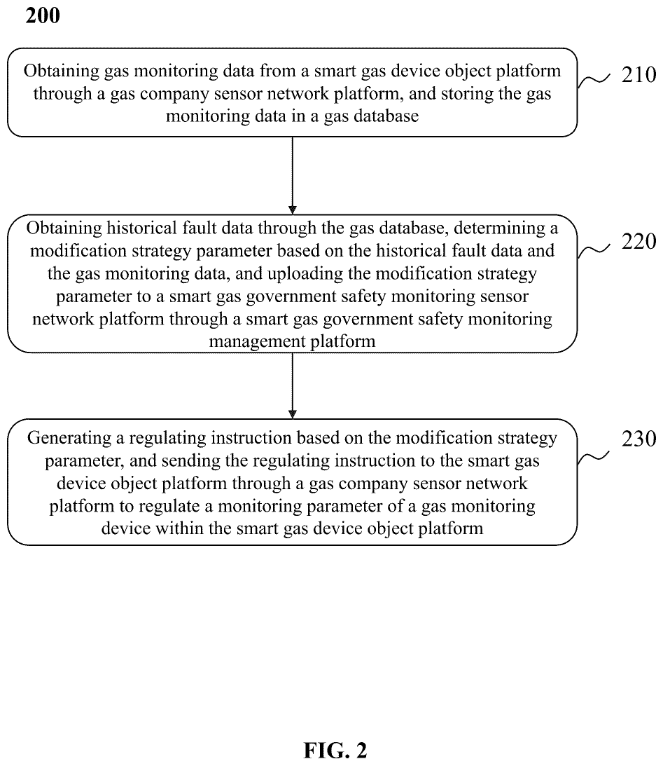

More descriptions regarding the foregoing details may be found in the related descriptions in connection with FIGS. 2 to 4.

In some embodiments of the present disclosure, based on the IoT system 100, an information closed loop may be formed among functional platforms to achieve coordinated and orderly operation, thereby realizing informatization and intelligence in modifying the smart gas pipeline network.

FIG. 2 is a flowchart illustrating an exemplary process for modifying a smart gas pipeline network based on IoT according to some embodiments of the present disclosure. In some embodiments, process 200 is executed by a gas company management platform of an IoT system for modifying a smart gas pipeline network (hereinafter referred to as the company management platform). As shown in FIG. 2, the process 200 includes the following operations.

In some embodiments, the company management platform may obtain gas monitoring data from a smart gas device object platform through a gas company sensor network platform and store the gas monitoring data in a gas database. The company management platform may obtain historical fault data through the gas database, determine a modification strategy parameter based on the historical fault data and the gas monitoring data, and upload the modification strategy parameter to a smart gas government safety monitoring sensor network platform through a smart gas government safety monitoring management platform. The company management platform may generate a regulating instruction based on the modification strategy parameter, and send the regulating instruction to the smart gas device object platform through the gas company sensor network platform to regulate a monitoring parameter of a gas monitoring device within the smart gas device object platform.

More descriptions regarding each platform of the IoT system for modifying the smart gas pipeline network may be found in the related descriptions in connection with FIG. 1.

In 210, the gas monitoring data is obtained from the smart gas device object platform through the gas company sensor network platform, and the gas monitoring data is stored in the gas database.

The gas monitoring data refers to data obtained by monitoring the interior and/or exterior of a gas pipeline. In some embodiments, the gas monitoring data may include internal monitoring data and external monitoring data. The internal monitoring data include at least one of a gas flow velocity, a gas temperature, a gas pressure, or a gas composition. The external monitoring data include at least one of an ambient temperature or an ambient humidity.

In some embodiments, the gas monitoring data may be acquired by a plurality of gas monitoring devices arranged inside and/or outside the gas pipeline and sent to the device object platform. The company management platform may obtain the gas monitoring data from the device object platform and store the gas monitoring data in the gas database. More descriptions regarding the gas monitoring devices may be found in FIG. 1 and related descriptions thereof.

In some embodiments, the company management platform may obtain the gas monitoring data from the device object platform through the gas company sensor network platform.

In 220, the historical fault data is obtained through the gas database, the modification strategy parameter is determined based on the historical fault data and the gas monitoring data, and the modification strategy parameter is uploaded to the smart gas government safety monitoring management platform through the smart gas government safety monitoring sensor network platform.

The modification strategy parameter refers to a parameter used for guiding pipeline modification. In some embodiments, the modification strategy parameter may include data of pipelines to be modified and construction parameters, or the like.

The data of pipelines to be modified refers to data related to the pipelines to be modified, e.g., data related to aging pipelines and pipelines with frequent faults. In some embodiments, the company management platform may assign identification numbers to all gas pipelines, and the data of pipelines to be modified may include identification numbers of the pipelines to be modified.

The construction parameters refer to parameters for performing modification construction on the pipelines to be modified. In some embodiments, the construction parameters may include a modification manner of the pipelines to be modified. The modification manner may include pipeline replacement, pipeline repair, accessory replacement, or the like.

The pipeline replacement refers to the operation of replacing an original pipeline by slotting and excavating the original pipeline. The pipeline repair refers to the operation of repairing an old pipeline without excavation. The accessory replacement refers to the operation of replacing accessories without excavating the old pipeline.

The historical fault data refers to fault data of gas pipelines within a historical time period. In some embodiments, the fault data may include a fault location, a fault type, a fault time, or the like. The fault type may include leakage, corrosion, or the like.

In some embodiments, the company management platform may obtain the historical fault data from the gas database. When a gas pipeline has a fault, the device object platform may upload the fault data to the gas database.

In some embodiments, the company management platform may determine the modification strategy parameter based on the historical fault data and the gas monitoring data.

In some embodiments, the company management platform may determine the pipelines to be modified in various manners based on the historical fault data and the gas monitoring data. For example, the company management platform may count a count and/or frequency of faults occurring in the gas pipeline within a historical time period based on the historical fault data of the gas pipeline and determine whether the count and/or frequency satisfies a fault condition. In response to the count and/or frequency satisfying the fault condition, the gas pipeline may be determined as a pipeline to be modified. The preset fault condition may include a count and/or a frequency greater than a fault threshold. The fault threshold may include a threshold corresponding to the count and the frequency and may be preset based on historical experience.

As another example, the company management platform may, based on a variation of gas composition data in the gas monitoring data, determine a variation range of the gas composition in the gas pipeline within a preset time period, and determine whether the variation range of the gas composition data satisfies a preset fault condition. In response to the variation range of the gas composition data satisfying the preset fault condition, the gas pipeline may be determined as a pipeline to be modified. The preset fault condition may include a variation range of the gas composition data greater than a variation threshold. The variation threshold and the preset time period may be preset based on historical experience. The gas composition may be obtained by gas analyzers in the gas monitoring devices.

In some embodiments, the company management platform may determine the construction parameters in various manners based on the historical fault data and the gas monitoring data. For example, the company management platform may, based on the historical fault data of gas pipelines, determine a count and/or a frequency of faults occurring in gas pipelines within a historical time period, query a first preset table for a first construction parameter corresponding to the count and/or the frequency, and determine the first construction parameter as the construction parameter.

In some embodiments, the first preset table may be preset based on historical experience and may include a plurality of groups of counts and/or frequencies and the first construction parameter corresponding to each group of counts and/or frequencies. The higher the group of counts and/or frequencies, the more the corresponding first construction parameter tends to be set as pipeline replacement.

As another example, the company management platform may, based on the gas monitoring data, determine a variation range of gas composition in the gas monitoring data, query a second preset table for a second construction parameter corresponding to the variation range, and determine the second construction parameter as the construction parameter.

In some embodiments, the second preset table may be preset based on historical experience and may include a plurality of groups of historical variation ranges of gas composition and a second construction parameter corresponding to each group of historical variation ranges. The larger the group of historical variation ranges, the more the corresponding second construction parameter tends to be set as pipeline replacement.

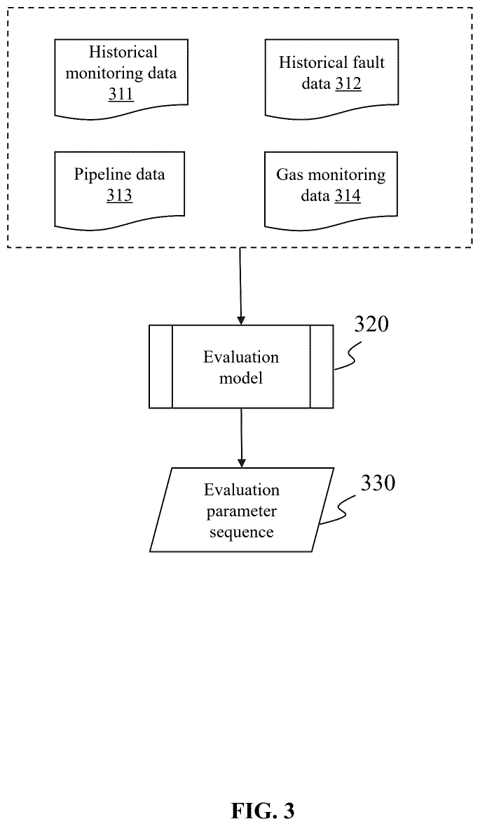

In some embodiments, the company management platform may determine the construction parameter based on the pipelines to be modified and an evaluation parameter sequence. More descriptions regarding this portion may be found in the related descriptions in connection with FIG. 3.

In 230, the regulating instruction is generated based on the modification strategy parameter, and the regulating instruction is sent to the smart gas device object platform through the gas company sensor network platform to regulate the monitoring parameter of the gas monitoring device within the smart gas device object platform.

The regulating instruction refers to an instruction for regulating the monitoring parameters of the gas monitoring device.

The monitoring parameters refer to parameters related to the operation of the gas monitoring device. In some embodiments, the monitoring parameters may include a monitoring frequency and a monitoring accuracy of the gas monitoring device.

In some embodiments, the company management platform may increase the monitoring frequency and monitoring accuracy of the gas monitoring device of the pipelines to be modified based on the modification strategy parameter, generate the regulating instruction based on the gas monitoring device and the updated monitoring frequency and monitoring accuracy, and send the regulating instruction to the device object platform through the gas company sensor network platform to regulate the monitoring parameter of the gas monitoring device corresponding to the regulating instruction.

It should be understood that, since the pipelines to be modified may be prone to accidents, it is necessary to increase the monitoring frequency and the monitoring accuracy of the gas monitoring device, so as to prevent situations in gas pipelines from deteriorating without timely response before modification, thereby facilitating timely adjustments of the construction parameters when the situations deteriorate.

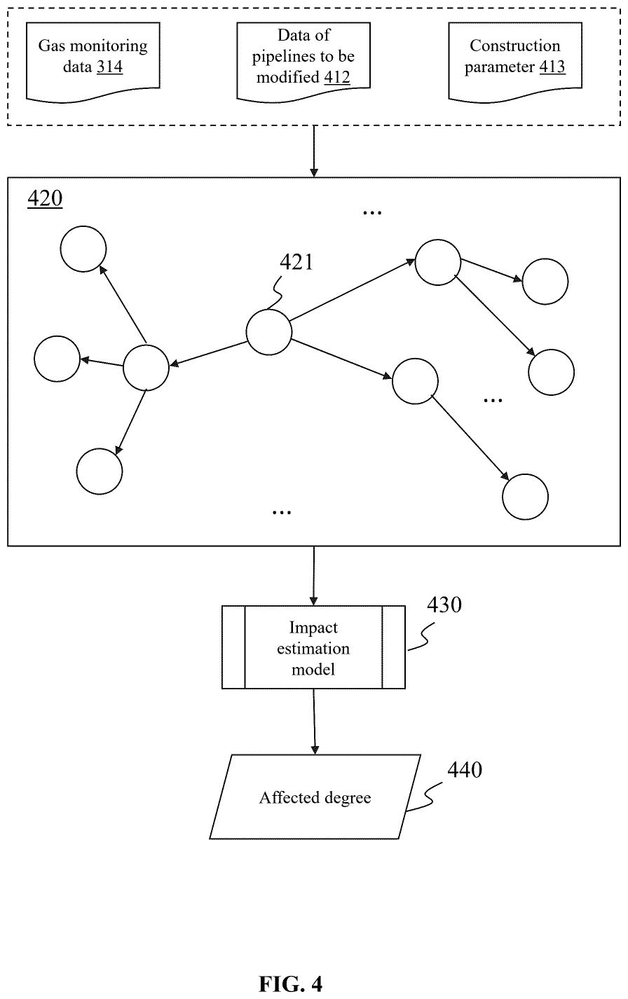

In some embodiments, the company management platform may generate an indirect regulating instruction based on a monitoring intensity and send the indirect regulating instruction to the device object platform through the gas company sensor network platform to regulate monitoring parameters of a gas monitoring device corresponding to an affected region. More descriptions regarding this portion may be found in FIG. 4 and related descriptions thereof.

In some embodiments of the present disclosure, by monitoring states such as temperature and humidity inside and outside gas pipelines, faults of gas pipelines may be monitored in real time and with high accuracy, so as to timely identify gas pipelines that need to be modified, and determine a suitable modification manner based on the gas database, thereby ensuring the safety of gas transmission.

It should be noted that the foregoing description regarding the process 200 is merely for purposes of illustration and explanation, and is not intended to limit the scope of the present disclosure. Various modifications and changes to the process 200 may be made by a person skilled in the art under the guidance of the present disclosure. However, these modifications and changes are still within the scope of the present disclosure.

FIG. 3 is a schematic diagram illustrating an exemplary evaluation model according to some embodiments of the present disclosure.

In some embodiments, the company management platform may obtain historical monitoring data 311 from the gas database and determine an evaluation parameter sequence 330 through an evaluation model 320 based on the historical monitoring data 311, historical fault data 312, pipeline data 313, and gas monitoring data 314. In response to determining that the evaluation parameter sequence 330 satisfies a preset condition, the company management platform may determine the pipelines to be modified. The company management platform may determine the construction parameter based on the pipelines to be modified and the evaluation parameter sequence. In response to determining that a pipeline health score of the pipelines to be modified satisfies a first monitoring condition, the company management platform may generate a leakage monitoring instruction based on the pipeline health score, and send the leakage monitoring instruction to the device object platform through the gas company sensor network platform to control a crawling robot of the device object platform to move to the pipelines to be modified and perform leakage monitoring. More descriptions regarding the historical fault data and the gas monitoring data may be found in FIG. 2 and related descriptions thereof.

The historical monitoring data refers to gas monitoring data acquired by the gas monitoring device within a historical time period. In some embodiments, the company management platform may obtain the historical monitoring data from the gas database.

The evaluation parameter sequence refers to a sequence composed of a plurality of evaluation parameters. The evaluation parameter sequence may include a plurality of historical evaluation parameters and a current evaluation parameter. The evaluation parameter refers to a parameter for evaluating the operating state of a pipeline.

In some embodiments, the evaluation parameter may include delivery fluctuation, corrosion degree, potential risk, and a confidence level of the potential risk, or the like. The delivery fluctuation may characterize the fluctuation degree of the gas flow delivered through the gas pipeline. The delivery fluctuation, the corrosion degree, and the confidence level of the potential risk may be represented as percentages. The larger percentage representing the delivery fluctuation indicates the greater fluctuation of the gas flow delivered through the gas pipeline.

In some embodiments, the potential risk may include at least one of a leakage risk, a stress risk, a geological risk, an interface risk, or a fracture risk. Each risk corresponds to a confidence level. The leakage risk refers to a possible occurrence of gas leakage. The stress risk refers to a risk possibly caused by stress variations resulting from temperature changes, pressure fluctuations, or the like. The geological risk refers to a risk possibly resulting from variations in the geological conditions of a region where the gas pipeline is located. The interface risk refers to a risk of sealing and stability at pipeline interfaces. The fracture risk refers to a risk of pipeline fracture possibly caused by pipeline aging, corrosion, or the like.

In some embodiments, the company management platform may determine the evaluation parameter sequence through the evaluation model based on the historical monitoring data, the historical fault data, the pipeline data, and the gas monitoring data. The company management platform may designate a plurality of evaluation parameters determined through the evaluation model within a historical time period as a plurality of historical evaluation parameters and combine these historical evaluation parameters with the current evaluation parameter to form the evaluation parameter sequence.

The pipeline data refers to data related to gas pipelines. In some embodiments, the pipeline data may include pipeline parameter data, pipeline interface data, and geological parameter data. If the gas pipeline is located on the ground surface, the pipeline data does not include geological parameter data. In some embodiments, the pipeline data may be uploaded to the company management platform by the gas company.

The pipeline parameter data refers to data related to the gas pipeline. In some embodiments, the pipeline parameter data may include at least one of a pipeline material, a pipeline size, a pipeline length, or lining parameters.

The pipeline interface data refers to data related to an interface of the gas pipeline. In some embodiments, the pipeline interface data may include a type and a state of the pipeline interface.

The geological parameter data refers to data related to the geology of a region where the gas pipeline is located. In some embodiments, the geological parameter data may include at least one of a pipeline burial depth, soil data, geological structure parameters, or ground vibration frequencies.

The evaluation model refers to a model for determining evaluation parameters. In some embodiments, the evaluation model may be a machine learning model. For example, the evaluation model may include at least one of a recurrent neural network (RNN) model or other customized model structures.

In some embodiments, the company management platform may train the evaluation model based on a plurality of first training samples with first labels through a gradient descent algorithm or the like. Each first training sample may include sample historical monitoring data, sample historical fault data, sample pipeline data, and sample gas monitoring data. The first label of each first training sample may be an actual evaluation parameter.

In some embodiments, the first training samples may be obtained based on historical data. The first labels may be determined by manual labeling. For example, delivery fluctuation and corrosion degree included in the first labels may be manually measured using instruments such as flowmeters and corrosion detectors. Potential risks and confidence levels thereof may be obtained through manual on-site inspection and evaluation.

In some embodiments, the evaluation model may be trained as follows. A plurality of first training samples with first labels are input into an initial evaluation model, a loss function is constructed based on the first labels and predicted results of the initial evaluation model, and the initial evaluation model is iteratively updated based on the loss function. The training of the evaluation model is completed when the loss function of the initial evaluation model satisfies a preset loss condition. The preset loss condition may include the loss function converging or a count of iteration reaching a set value.

In some embodiments, in response to determining that the evaluation parameter sequence satisfies the preset condition, the pipelines to be modified may be determined.

The preset condition refers to a condition for determining whether the gas pipeline needs to be modified. In some embodiments, the preset condition may be preset based on historical experience and may include a plurality of parameter thresholds. Each parameter threshold corresponds to one item of data in the evaluation parameters.

In some embodiments, the company management platform may determine the pipelines to be modified based on current evaluation parameters. For example, if any of the delivery fluctuation, the corrosion degree, or the confidence level of a potential risk in the evaluation parameters exceeds a corresponding parameter threshold in the preset condition, the company management platform may determine the gas pipeline as a pipeline to be modified.

In some embodiments, the preset condition may further include a health score threshold. The company management platform may determine the pipeline health score based on the evaluation parameters. In response to determining that the pipeline health score is below the health score threshold in the preset condition, the gas pipeline may be determined as a pipeline to be modified. The health score threshold may be preset based on historical experience.

The pipeline health score may characterize the likelihood of faults occurring in the gas pipeline. A lower pipeline health score indicates a greater likelihood of faults in the gas pipeline.

In some embodiments, the pipeline health score may be related to the delivery fluctuation, the corrosion degree, the potential risk, and the confidence level of the potential risk. For example, the pipeline health score may be negatively correlated with the delivery fluctuation, the corrosion degree, the potential risk, and the confidence level of the potential risk. Merely by way of example, the company management platform may determine the pipeline health score according to the following equation (1):

$$H = 100 - ( a 1 \times S 1 + a 2 \times S 2 + a 3 \times S 3 + a 4 \times S 4 + a 5 \times S 5 + a 6 \times S 6 + a 7 \times S 7 ) \qquad ( 1 )$$

H denotes the pipeline health score, S1 denotes the delivery fluctuation, S2 denotes the corrosion degree, S3 denotes a confidence level of a leakage risk, S4 denotes a confidence level of a stress risk, S5 denotes a confidence level of a geological risk, S6 denotes a confidence level of an interface risk, S7 denotes a confidence level of a fracture risk, and a1-a7 denote coefficients. The coefficients a1-a7 may be preset based on historical experience.

In some embodiments, the company management platform may determine the pipelines to be modified based on the evaluation parameter sequence. For example, the company management platform may determine a plurality of historical pipeline health scores based on a plurality of historical evaluation parameters in the evaluation parameter sequence. In response to determining that an average variation range of the plurality of historical pipeline health scores is greater than a preset variation threshold, the gas pipeline is determined as the pipeline to be modified. The variation range may be characterized by a difference between a former historical pipeline health score and a latter historical pipeline health score. The preset variation threshold may be preset based on historical experience.

In some embodiments, the company management platform may query a preset parameter table for historical evaluation parameters matching the evaluation parameters and determine a reference construction parameter corresponding to the historical evaluation parameters as the construction parameter of the pipeline to be modified. The preset parameter table may be preset based on historical data and may include a plurality of historical evaluation parameters and a reference construction parameter corresponding to each historical evaluation parameter. The reference construction parameter may be a construction parameter actually adopted in a historical modification process.

The leakage monitoring instruction refers to an instruction for indicating whether gas leakage occurs in the gas pipeline.

In some embodiments, in response to determining that the pipeline health score of the pipelines to be modified satisfies the first monitoring condition, the company management platform may generate a leakage monitoring instruction based on the pipeline health score. The first monitoring condition may include that the pipeline health score is lower than a leakage monitoring threshold. The leakage monitoring threshold may be preset based on historical experience.

In some embodiments, the leakage monitoring instruction may be sent to the device object platform through the gas company sensor network platform to control the crawling robot of the device object platform to move to the pipelines to be modified and perform leakage monitoring. The crawling robot may be equipped with leakage monitoring devices and may crawl along the outer surface of the pipeline to perform leakage monitoring.

The leakage monitoring devices refer to devices for monitoring gas content outside the pipeline. For example, the leakage monitoring devices may include a gas leakage detector, a gas sensor, or the like.

In some embodiments of the present disclosure, the pipelines to be modified and corresponding construction parameters in the gas pipeline network may be rapidly determined based on evaluation parameters of gas pipelines, thereby ensuring precision and smoothness of gas pipeline network modification. Through leakage monitoring performed by the crawling robot on gas pipelines that may potentially leak, gas leakage events may be responded on time.

In some embodiments, the evaluation parameter sequence may further include a predicted evaluation parameter, and the evaluation model may further include a prediction layer and an evaluation layer. The company management platform may construct a pipeline map based on the historical monitoring data, the historical fault data, the gas monitoring data, future weather data, the evaluation parameter sequence, and the pipeline data, determine predicted monitoring data and predicted fault data through the prediction layer based on the pipeline map, and determine the predicted evaluation parameter based on the predicted monitoring data, the predicted fault data, the historical monitoring data, the historical fault data, the gas monitoring data, and the pipeline data through the evaluation layer.

In some embodiments, the prediction layer and the evaluation layer may be trained separately.

The pipeline map refers to a graph structure characterizing association relationships between gas monitoring devices and pipeline interfaces. The graph structure is a data structure composed of nodes and edges, where edges connect the nodes, and the nodes and edges may have features.

In some embodiments, the company management platform may construct the pipeline map based on connection relationships between the gas monitoring devices and pipeline interfaces. The nodes of the pipeline map may include interface nodes and device nodes. The interface nodes refer to nodes representing the locations of pipeline interfaces. The device nodes refer to nodes representing the locations of the gas monitoring devices.

In some embodiments, node features may include interface node features and device node features. The interface node features may include the pipeline data and the historical fault data. The device node features may include the gas monitoring data, the historical monitoring data, or the like.

The edges of the pipeline map may characterize connectivity between nodes. In some embodiments, each edge of the pipeline map may correspond to a gas pipeline connecting the nodes. Edge features corresponding to each edge may include the historical fault data, the future weather data, and the evaluation parameter sequence, etc., of the pipelines corresponding to the edges. Directions of edges correspond to directions of gas flow.

The future weather data refers to weather conditions at future times. For example, the company management platform may obtain future weather data through external meteorological platforms or weather forecasts.

In some embodiments, the prediction layer refers to a model for determining the predicted monitoring data and the predicted fault data. In some embodiments, the prediction layer may be a machine learning model. For example, the prediction layer may include at least one of a graph neural network (GNN) model or other customized model structures.

In some embodiments, outputs of the prediction layer may include the predicted monitoring data output by the device nodes and the predicted fault data output by the edges.

The predicted monitoring data refers to gas monitoring data predicted for future time. In some embodiments, the predicted monitoring data may include the gas monitoring data at a plurality of future time points. The plurality of future time points may be preset based on historical experience.

The predicted fault data refers to fault types predicted as possibly occurring at future times. In some embodiments, the predicted fault data may include fault types possibly occurring at a plurality of future time points. If no fault is predicted to occur in the gas pipeline at a future time point, the predicted fault data is empty.

In some embodiments, the company management platform may train the prediction layer based on a plurality of second training samples with second labels through a gradient descent algorithm or the like. Each second training sample may include a sample pipeline map. The second labels may include gas monitoring data and fault data actually obtained at historical time points. The second training samples and second labels may be obtained based on historical data. More descriptions regarding the fault data may be found in FIG. 2 and related descriptions thereof. The historical time points refer to time points corresponding to the predicted monitoring data and the predicted fault data output by the prediction layer at historical times. For example, if the prediction layer outputs predicted monitoring data and predicted fault data at 10 o'clock corresponding to 15 o'clock, then the historical time point is 15 o'clock.

In some embodiments, the training process of the prediction layer is similar to the training process of the evaluation model described above, and its implementation manner may refer to the training manner of the evaluation model described above.

In some embodiments, in response to determining that the predicted fault data satisfies a second monitoring condition, the company management platform may generate a fault monitoring instruction based on the predicted fault data, and send the fault monitoring instruction to the smart gas device object platform through the gas company sensor network platform to control the crawling robot of the smart gas device object platform to move to the pipelines to be modified and perform mobile patrol.

The pipelines to be modified refer to gas pipelines corresponding to the predicted fault data that satisfies the second monitoring condition.

The fault monitoring instruction refers to an instruction for indicating execution of mobile patrol. In some embodiments, the fault monitoring instruction may be configured to control the crawling robot in the pipelines to be modified to perform reciprocating mobile patrol centered on its current location within a preset length and to monitor whether faults occur in the pipelines to be modified during the mobile patrol.

In some embodiments, the preset length may be related to the detection sensitivity of the crawling robot and a fault point distribution. For example, the preset length may be negatively correlated with the detection sensitivity of the crawling robot and the density of the fault point distribution. A lower detection sensitivity and a sparser fault point distribution may result in a longer preset length.

The detection sensitivity refers to the capability of the crawling robot to detect the minimum fault signal. The fault point distribution refers to a distribution of fault locations in gas pipelines during historical time periods. In some embodiments, the company management platform may generate the fault point distribution based on the fault locations in the historical fault data. The shorter the distance between the fault locations, the higher the density of the fault point distribution. The detection sensitivity may be uploaded to the company management platform by the gas company.

In some embodiments of the present disclosure, the patrol length may be reasonably set based on the detection sensitivity of the crawling robot and the fault point distribution. On the premise of ensuring monitoring effectiveness, unnecessary patrol length may be reduced. Even when the detection sensitivity of the crawling robot is relatively low, a longer patrol length may help the crawling robot cover more regions and improve the probability of detecting potential faults.

In some embodiments, in response to determining that the predicted fault data satisfies a second monitoring condition, the company management platform may generate a fault monitoring instruction based on the predicted fault data. The second monitoring condition may include that the predicted fault data is not empty.

In some embodiments, the company management platform may send the fault monitoring instruction to the device object platform to control the crawling robot of the device object platform to move to the pipelines to be modified and perform mobile patrol.

In some embodiments of the present disclosure, gas leakage may often be dynamic, thus fixing the crawling robot at one position for detection can result in delayed detection and slow response. By analyzing the predicted fault data and generating the fault monitoring instruction, the crawling robot can be timely controlled to move to the pipelines to be modified and perform the mobile patrol, thus expanding a monitoring range, reducing monitoring blind spots, and timely identifying potential faults.

The evaluation layer refers to a model for determining the predicted evaluation parameter. In some embodiments, the evaluation layer may be a machine learning model. For example, the evaluation layer may include at least one of a recurrent neural network (RNN) model or other customized model structures.

In some embodiments, inputs of the evaluation layer may include the historical monitoring data, the historical fault data, and the pipeline data, and outputs of the evaluation layer may include the predicted evaluation parameters. The historical monitoring data may include current gas monitoring data and predicted monitoring data output by the prediction layer. The historical fault data may include the predicted fault data output by the prediction layer.

The predicted evaluation parameter refers to an evaluation parameter predicted for future time. In some embodiments, the predicted evaluation parameter may include evaluation parameters at a plurality of future time points.

In some embodiments, the company management platform may sequentially determine the predicted evaluation parameter at each future time point among the plurality of future time points through the evaluation layer. When determining the predicted evaluation parameter at a future time point, the historical monitoring data and the historical fault data input to the evaluation layer may include predicted monitoring data and predicted fault data corresponding to the future time point, as well as predicted monitoring data and predicted fault data corresponding to future time points before the future time point.

Merely by way of example, when determining a predicted evaluation parameter at a second future time point through the evaluation layer, historical monitoring data and historical fault data input to the evaluation layer may further include predicted monitoring data and predicted fault data corresponding to the second future time point as well as predicted monitoring data and predicted fault data corresponding to a first future time point. The second future time point is later than the first future time point.

In some embodiments, the training manner and process of the evaluation layer are similar to the training manner and process of the evaluation model described above, and the implementation may refer to the training manner and process of the evaluation model described above. The difference is that the company management platform may use third training samples and third labels. Each third training sample may include sample historical monitoring data, sample historical fault data, sample pipeline data, sample gas monitoring data, sample predicted monitoring data, and sample predicted fault data. Each third label may include actual evaluation parameters at future time points. The sample predicted monitoring data and the sample predicted fault data may be obtained through the prediction layer. More descriptions regarding obtaining the sample historical monitoring data, the sample historical fault data, the sample pipeline data, the sample gas monitoring data, and the actual evaluation parameters may be found in related descriptions above.

In some embodiments, for gas pipelines that are not determined as the pipelines to be modified, the company management platform may determine a predicted pipeline health score corresponding to the predicted evaluation parameter based on the predicted evaluation parameter. In response to determining that the predicted pipeline health score is below a health score threshold, the gas pipeline may be determined as the pipeline to be modified. More descriptions regarding the pipeline health score and the health score threshold may be found in the related descriptions hereinabove.

In some embodiments, in response to determining that an average decreasing range of the predicted pipeline health score is greater than a preset range threshold, the company management platform may determine the gas pipeline as the pipeline to be modified. Merely by way of example, the company management platform may obtain a first difference by calculating a difference between a current pipeline health score and a predicted pipeline health score corresponding to the first future time point, and obtain a second difference by calculating a difference between a predicted pipeline health score corresponding to the second future time point and the predicted pipeline health score corresponding to the first future time point, and determine an average of the first difference and the second difference as the average decreasing range. More descriptions regarding the preset range threshold may be found in related descriptions hereinabove.

In some embodiments, the modification strategy parameter may further include a modification time point of pipelines to be modified. The modification time point refers to a time point for performing modification on the pipelines to be modified.

In some embodiments, the company management platform may determine the modification time point as the time point at which the predicted pipeline health score first falls below the health score threshold, based on predicted pipeline health scores corresponding to a plurality of future time points.

In some embodiments, the company management platform may query a preset parameter table for historical evaluation parameters matching predicted evaluation parameters at the modification time point, based on the predicted evaluation parameters at the modification time point and the pipelines to be modified, and determine a reference construction parameter corresponding to the historical evaluation parameters as the construction parameter of the pipelines to be modified. More descriptions regarding the preset parameter table may be found in FIG. 2 and related descriptions thereof.

In some embodiments of the present disclosure, the historical monitoring data, the historical fault data, the gas monitoring data, the future weather data, the evaluation parameter sequences, and the pipeline data may be effectively organized by constructing the pipeline map. Meanwhile, the predicted evaluation parameters may be rapidly and accurately determined by using the evaluation model with a hierarchical structure, thereby reducing the difficulty in training the evaluation model, enhancing the accuracy of the evaluation model, and facilitating easy adjustment and maintenance of the evaluation model.

FIG. 4 is a schematic diagram illustrating an exemplary impact estimation model according to some embodiments of the present disclosure.

In some embodiments, the modification strategy parameter may further include an affected degree of an affected region, and the regulating instruction may further include an indirect regulating instruction. The company management platform may construct a modification map 420 based on gas monitoring data 314, data of pipelines to be modified 412, and a construction parameter 413, and determine the affected degree 440 through an impact estimation model 430 based on the modification map 420. The company management platform may further determine a monitoring intensity corresponding to the affected region based on the affected degree 440, generate the indirect regulating instruction based on the monitoring intensity, and send the indirect regulating instruction to the device object platform through the gas company sensor network platform to regulate the monitoring parameter of gas the monitoring device corresponding to the affected region. More descriptions regarding the gas monitoring data, the data of pipelines to be modified, and the construction parameter may be found in FIGS. 2-3 and related descriptions thereof.

The indirect regulating instruction refers to an instruction for regulating the monitoring parameter of the gas monitoring device.

The affected degree of the affected region refers to the degree of influence on the affected region when construction is performed on pipelines to be modified. The affected region refers to a region affected due to the modification of the gas pipeline network. In some embodiments, the affected region may include the pipelines to be modified and regions where gas pipelines possibly affected are located. For example, the affected region may include the pipelines to be modified and pipelines surrounding the pipelines to be modified.

The modification map refers to a graph structure characterizing the association relationship between different gas monitoring devices.

In some embodiments, the company management platform may construct the modification map based on connection relationships between a plurality of gas monitoring devices. Nodes of the modification map may include monitoring device nodes (e.g., node 421), each representing a location of a gas monitoring device. Node features of the monitoring device nodes may include the historical monitoring data and the gas monitoring data corresponding to the gas monitoring devices. More descriptions regarding the historical monitoring data may be found in FIG. 2 and related descriptions thereof.

Edges of the modification map may characterize connectivity between nodes and are directional edges, whose directions correspond to gas flow directions. In some embodiments, edges of the modification map may include modification edges and general edges, both representing gas pipelines connecting nodes. The modification edges represent pipelines to be modified, and the general edges represent gas pipelines represent pipelines that are not pipelines to be modified.

In some embodiments, features of the modification edges may include pipeline parameter data, geological parameter data, the historical fault data, and the construction parameter. Features of the general edges may include pipeline parameter data, geological parameter data, the historical fault data, and the evaluation parameter sequences. More descriptions regarding the pipeline parameter data, the geological parameter data, the historical fault data, and the evaluation parameter sequences may be found in FIGS. 2-3 and related descriptions thereof.

In some embodiments, features of the modification edges and general edges may further include evaluation parameter sequences of gas pipelines corresponding to the edges.

In some embodiments of the present disclosure, since evaluation parameters may reflect actual conditions of gas pipelines, introducing the evaluation parameter into the modification map may more precisely estimate which regions will be influenced by the modification, as well as the affected degree thereof, thus avoiding damage to the affected region due to underestimating the affected degree.

The impact estimation model refers to a model for determining the affected degree. In some embodiments, the impact estimation model may be a machine learning model. For example, the impact estimation model may include at least one of a graph neural network (GNN) model or other customized model structures.

In some embodiments, inputs of the impact estimation model may include the modification map, and outputs of the impact estimation model may include the affected region and the affected degree of the affected region.

In some embodiments, the impact estimation model may be obtained through training based on a training sample set. The training sample set may include a plurality of training samples and a label corresponding to each training sample of the plurality of training samples. Each training sample of the plurality of training samples may include a sample modification map. The label corresponding to each training sample of the plurality of training samples may be an actual affected degree of an affected region.

In some embodiments, the company management platform may train the impact estimation model based on the training sample set through a gradient descent algorithm or the like. The training manner of the impact estimation model may be similar to the training manner of the evaluation model, and its implementation manner may refer to the training manner of the evaluation model.

In some embodiments, the training sample set may be obtained based on historical data. For example, the company management platform may construct the sample modification map based on historical gas monitoring data, historical data of pipelines to be modified, and historical construction parameters in the historical data, determine a region actually affected during the modification of the pipelines to be modified as the affected region, and determine an actual affected degree of the affected region as the label.

In some embodiments, the label corresponding to each training sample may be determined based on a data variation range of gas monitoring data and/or a vibration amplitude in the modification process. For example, the company management platform may obtain gas monitoring data of general edges in the sample modification map before and after construction of modification edges, determine a data variation range of the gas monitoring data before and after construction, determine general edges with the data variation range greater than a variation threshold as the affected region in the label, and determine an actual affected degree of the affected region through a preset correspondence relationship. The variation threshold may be preset based on historical experience.

The preset correspondence relationship may be preset based on historical experience. In some embodiments, the preset correspondence relationship may include that the affected degree is positively correlated with the data variation range. A larger data variation range corresponds to a higher affected degree.

In some embodiments, the company management platform may also obtain average vibration amplitudes of general edges before and after the construction of modification edges by using vibration sensors deployed on gas pipelines corresponding to the general edges. General edges with an average vibration amplitude greater than a vibration threshold may be determined as the affected region in the label, and an actual affected degree of the affected region may be determined through the preset correspondence relationship. The preset correspondence relationship herein may include that the affected degree is positively correlated with the average vibration amplitude. A greater average vibration amplitude corresponds to a higher affected degree. The vibration threshold may be preset based on historical experience.

The vibration sensor refers to a device configured to collect vibration amplitudes of pipelines based on a collection frequency. The collection frequency may be preset based on historical experience. The average vibration amplitude refers to an average value of vibration amplitudes collected based on the collection frequency.

In some embodiments, the company management platform may also perform a weighted summation of the average vibration amplitude and the data variation range. The result of the weighted summation may be determined as the affected degree. Weights for the weighted summation may be preset based on historical experience.

In some embodiments, a count of training samples corresponding to each remodeling manner in the training sample set may satisfy a preset count condition.

The preset count condition refers to a condition for constraining counts of training samples corresponding to different remodeling manners in the training sample set. In some embodiments, the preset count condition may include that the count of training samples corresponding to each remodeling manner is not less than a corresponding count threshold. The count threshold corresponding to attachment replacement may be less than the count threshold corresponding to pipeline repair, and the count threshold corresponding to pipeline repair may be less than the count threshold corresponding to pipeline replacement. More descriptions regarding the modification manner may be found in FIG. 2 and related descriptions thereof.

In some embodiments, the value of each count threshold may be preset. For example, the value of the count threshold may be positively correlated with an average modification cost of the corresponding modification manner. The average modification cost of a modification manner refers to an average value of costs incurred by performing the modification manner a plurality of times during historical periods.

In some embodiments of the present disclosure, by setting the count of training samples corresponding to each modification manner in the training sample set to satisfy the preset count condition, the impact estimation model may maintain good generalization capability when facing different types of modification manners. By installing vibration sensors on pipelines surrounding the pipelines to be modified and determining the affected degree based on the data variation range of gas monitoring data, potential safety hazards may be identified on time.

The monitoring intensity refers to data characterizing the intensity of monitoring performed by gas monitoring devices within the affected region. In some embodiments, the monitoring intensity may include a collection frequency of the gas monitoring device.

In some embodiments, the company management platform may determine the monitoring intensity based on the affected degree and an importance level of the affected region according to a preset intensity relationship. The preset intensity relationship may include that the monitoring intensity is positively correlated with the affected degree and the importance level of the affected region.

The importance level of the affected region refers to the degree to which the affected region needs to be monitored.

In some embodiments, the company management platform may determine the importance level of the affected region based on importance levels of gas pipelines within the affected region. When the affected region includes a plurality of gas pipelines, the importance level of the affected region may be determined as an average of the importance levels of the plurality of gas pipelines.

The importance level of a gas pipeline refers to the degree to which the gas pipeline needs to be monitored. In some embodiments, the company management platform may determine the importance level of a gas pipeline by performing a weighted calculation based on the average gas flow rate of the gas pipeline and the population density of a region where the gas pipeline is located. Weights used for the weighted calculation may be preset based on historical experience. The average gas flow rate may be obtained from the device object platform. The population density may be obtained through user input or the like.

In some embodiments, the company management platform may generate the indirect regulating instruction based on the monitoring intensity and send the indirect regulating instruction to the device object platform through the gas company sensor network platform to regulate the monitoring parameter of the gas monitoring device corresponding to the affected region to be consistent with monitoring parameters included in the monitoring intensity.

In some embodiments, in response to determining that the monitoring intensity and/or the affected degree satisfy a third monitoring condition, a monitoring expansion instruction is generated based on the monitoring intensity and/or the affected degree. The monitoring expansion instruction is sent to the smart gas device object platform via the gas company sensor network platform to control the crawling robot of the smart gas device object platform to move to the affected region and add the gas monitoring device and/or vibration sensors.

The monitoring expansion instruction refers to an instruction for indicating the addition of the gas monitoring device and/or the vibration sensors. In some embodiments, in response to determining that the monitoring intensity and/or the affected degree satisfy the third monitoring condition, the company management platform may generate the monitoring expansion instruction based on the monitoring intensity and/or the affected degree. The third monitoring condition may include that the monitoring intensity is greater than a monitoring limit threshold and/or the affected degree is greater than an affected threshold.

In some embodiments, the monitoring limit threshold refers to a maximum collection frequency that may be achieved by the gas monitoring device. In some embodiments, the affected threshold may be positively correlated with the importance level of the affected region. A higher importance level corresponds to a greater affected threshold.

In some embodiments, in response to determining that the affected degree satisfies the third monitoring condition, the company management platform may determine a count of vibration sensors to be added based on a length of pipelines in the affected region and a correspondence relationship between the length and the count of sensors to be added. Positions for adding the vibration sensors may be evenly distributed along the pipelines. The monitoring expansion instruction may be generated based on the count and positions of the additional vibration sensors. The correspondence relationship may include that the count is positively correlated with the length.

In some embodiments, in response to determining that the monitoring intensity satisfies the third monitoring condition, the company management platform may add a count of gas monitoring devices at the original positions of the gas monitoring devices to satisfy the required monitoring intensity based on the monitoring intensity and the monitoring limit threshold. The monitoring expansion instruction may be generated based on the positions and count of the added gas monitoring devices, as well as time points for data acquisition.

Merely by way of example, when the monitoring intensity is 2 seconds per acquisition, the monitoring limit threshold is 4 seconds per acquisition, and the original gas monitoring device collects data at 0 s, 4 s, 8 s, . . . , then an additional gas monitoring device may be added at the same position of the gas monitoring device. The additional gas monitoring device collects data at 2 s, 6 s, 10 s, . . . , so that through staggered acquisition, a monitoring intensity of 2 seconds per acquisition is achieved.

In some embodiments, the company management platform may send the monitoring expansion instruction to the smart gas device object platform via the gas company sensor network platform to control the crawling robot of the smart gas device object platform to move to the affected region and add the gas monitoring device and/or the vibration sensors. The crawling robot may fix the added the gas monitoring device and/or the vibration sensors at positions where the addition is required based on the monitoring expansion instruction. The crawling robot may also carry the gas monitoring device and/or the vibration sensors and stand by at the required positions, so as to enable subsequent removal of the added gas monitoring device and/or vibration sensors.

In some embodiments of the present disclosure, by generating the monitoring expansion instruction and controlling the crawling robot to move to the affected region and add the gas monitoring device and/or vibration sensors, device for monitoring may be added on time when the current monitoring intensity for the affected region is insufficient, thereby ensuring effective monitoring of the affected region.

In some embodiments of the present disclosure, by constructing the modification map, the complex gas monitoring devices and related data can be effectively organized. The affected degree of the affected region can be quickly and accurately determined through the impact estimation model, and the monitoring intensity of the gas monitoring devices within the affected region can be determined based on the affected degree, thereby ensuring effective monitoring of the affected region.

In some embodiments of the present disclosure, a non-transitory computer-readable storage medium is further provided. The storage medium stores one or more sets of computer instructions. When a computer reads the one or more sets of computer instructions in the storage medium, the computer implements any of the methods described in the above embodiments.

In addition, some features, structures, or characteristics of one or more embodiments in the present disclosure may be properly combined.

In some embodiments, the numbers expressing quantities or properties used to describe and claim certain embodiments of the present disclosure are to be understood as being modified in some instances by the term “about”, “approximate”, or “substantially”. For example, “about”, “approximate”, or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

In case of any inconsistency or conflict between the descriptions, definitions, and/or terms used in materials cited in the present disclosure and those described in the present disclosure, the descriptions, definitions, and/or terms used in the present disclosure shall prevail.

What is claimed is:

1. A method for modifying a smart gas pipeline network based on Internet of Things (IoT), the method being executed by a gas company management platform of an IoT system for modifying a smart gas pipeline network, the method comprising:
obtaining gas monitoring data from a smart gas device object platform through a gas company sensor network platform, and storing the gas monitoring data in a gas database;
obtaining historical fault data through the gas database, determining a modification strategy parameter based on the historical fault data and the gas monitoring data, and uploading the modification strategy parameter to a smart gas government safety monitoring sensor network platform through a smart gas government safety monitoring management platform, wherein the modification strategy parameter includes at least one of data of pipelines to be modified and a construction parameter of the pipelines to be modified; and
generating a regulating instruction based on the modification strategy parameter, and sending the regulating instruction to the smart gas device object platform through the gas company sensor network platform to regulate a monitoring parameter of a gas monitoring device within the smart gas device object platform.

2. The method of claim 1, further comprising:
obtaining historical monitoring data through the gas database, and determining, based on the historical monitoring data, the historical fault data, pipeline data, and the gas monitoring data, an evaluation parameter sequence through an evaluation model, wherein the evaluation model is a machine learning model;
in response to determining that the evaluation parameter sequence satisfies a preset condition, determining the pipelines to be modified;
determining the construction parameter based on the pipelines to be modified and the evaluation parameter sequence; and
in response to determining that a pipeline health score of the pipelines to be modified satisfies a first monitoring condition, generating a leakage monitoring instruction based on the pipeline health score, and sending the leakage monitoring instruction to the smart gas device object platform through the gas company sensor network platform to control a crawling robot of the smart gas device object platform to move to the pipelines to be modified and perform leakage monitoring.

3. The method of claim 2, wherein the evaluation parameter sequence includes a predicted evaluation parameter, the evaluation model includes a prediction layer and an evaluation layer, and the obtaining historical monitoring data through the gas database, and determining, based on the historical monitoring data, the historical fault data, pipeline data, and the gas monitoring data, an evaluation parameter sequence through an evaluation model includes:
constructing a pipeline map based on the historical monitoring data, the historical fault data, the gas monitoring data, future weather data, the evaluation parameter sequence, and the pipeline data;
determining predicted monitoring data and predicted fault data through the prediction layer based on the pipeline map; and
determining the predicted evaluation parameter based on the predicted monitoring data, the predicted fault data, the historical monitoring data, the historical fault data, the gas monitoring data, and the pipeline data through the evaluation layer.

4. The method of claim 3, further comprising:
in response to determining that the predicted fault data satisfies a second monitoring condition, generating a fault monitoring instruction based on the predicted fault data, and sending the fault monitoring instruction to the smart gas device object platform through the gas company sensor network platform to control the crawling robot of the smart gas device object platform to move to the pipelines to be modified and perform mobile patrol.

5. The method of claim 1, wherein the modification strategy parameter further includes an affected degree of an affected region, the regulating instruction further includes an indirect regulating instruction, and the method further comprises:
constructing a modification map based on the gas monitoring data, the data of pipelines to be modified, and the construction parameter;
determining the affected degree through an impact estimation model based on the modification map, wherein the impact estimation model is a machine learning model;
determining a monitoring intensity corresponding to the affected region based on the affected degree; and
generating the indirect regulating instruction based on the monitoring intensity and sending the indirect regulating instruction to the smart gas device object platform through the gas company sensor network platform to regulate the monitoring parameter of the gas monitoring device corresponding to the affected region.

6. The method of claim 5, wherein the impact estimation model is obtained through training based on a training sample set, and the training sample set includes a plurality of training samples and a label corresponding to each training sample of the plurality of training samples; and
each training sample of plurality of the training samples includes a sample modification map, the label corresponding to each training sample of plurality of training samples is an actual affected degree of the affected region, and the label is determined based on a data variation range of the gas monitoring data and/or a vibration amplitude in a remodeling process, and a count of training samples in the training sample set corresponding to each remodeling manner satisfies a preset count condition.

7. The method of claim 5, further comprising:
in response to determining that the monitoring intensity and/or the affected degree satisfy a third monitoring condition, generating a monitoring expansion instruction based on the monitoring intensity and/or the affected degree; and
sending the monitoring expansion instruction to the smart gas device object platform via the gas company sensor network platform to control the crawling robot of the smart gas device object platform to move to the affected region and add the gas monitoring device and/or vibration sensors.

8. An Internet of Things (IoT) system for modifying a smart gas pipeline network, comprising a smart gas government safety monitoring management platform, a smart gas government safety monitoring sensor network platform, a smart gas government safety monitoring object platform, a gas company sensor network platform, a smart gas device object platform, wherein the smart gas government safety monitoring object platform includes a gas company management platform; and the gas company management platform is configured to:
obtain gas monitoring data from the smart gas device object platform through the gas company sensor network platform, and store the gas monitoring data in a gas database;
obtain historical fault data through the gas database, determine a modification strategy parameter based on the historical fault data and the gas monitoring data, and upload the modification strategy parameter to the smart gas government safety monitoring sensor network platform through the smart gas government safety monitoring management platform, wherein the modification strategy parameter includes at least one of data of pipelines to be modified and a construction parameter of the pipelines to be modified; and
generate a regulating instruction based on the modification strategy parameter, and send the regulating instruction to the smart gas device object platform through the gas company sensor network platform to regulate a monitoring parameter of a gas monitoring device within the smart gas device object platform.

9. The system of claim 8, wherein the gas company management platform is further configured to:
obtain historical monitoring data through the gas database, and determine, based on the historical monitoring data, the historical fault data, pipeline data, and the gas monitoring data, an evaluation parameter sequence through an evaluation model, wherein the evaluation model is a machine learning model;
in response to determining that the evaluation parameter sequence satisfies a preset condition, determine the pipelines to be modified;
determine the construction parameter based on the pipelines to be modified and the evaluation parameter sequence; and
in response to determining that a pipeline health score of the pipelines to be modified satisfies a first monitoring condition, generate a leakage monitoring instruction based on the pipeline health score, and send the leakage monitoring instruction to the smart gas device object platform through the gas company sensor network platform to control a crawling robot of the smart gas device object platform to move to the pipelines to be modified and perform leakage monitoring.

10. The system of claim 9, wherein the evaluation parameter sequence includes a predicted evaluation parameter, the evaluation model includes a prediction layer and an evaluation layer, and the gas company management platform is further configured to:
construct a pipeline map based on the historical monitoring data, the historical fault data, the gas monitoring data, future weather data, the evaluation parameter sequence, and the pipeline data;
determine predicted monitoring data and predicted fault data through the prediction layer based on the pipeline map; and
determine the predicted evaluation parameter based on the predicted monitoring data, the predicted fault data, the historical monitoring data, the historical fault data, the gas monitoring data, and the pipeline data through the evaluation layer.

11. The system of claim 10, wherein the gas company management platform is further configured to:
in response to determining that the predicted fault data satisfies a second monitoring condition, generate a fault monitoring instruction based on the predicted fault data, and send the fault monitoring instruction to the smart gas device object platform through the gas company sensor network platform to control the crawling robot of the smart gas device object platform to move to the pipelines to be modified and perform mobile patrol.

12. The system of claim 8, wherein the modification strategy parameter further includes an affected degree of an affected region, the regulating instruction further includes an indirect regulating instruction, and the gas company management platform is further configured to:
construct a modification map based on the gas monitoring data, the data of pipelines to be modified, and the construction parameter;
determine the affected degree through an impact estimation model based on the modification map, wherein the impact estimation model is a machine learning model;
determine a monitoring intensity corresponding to the affected region based on the affected degree; and
generate the indirect regulating instruction based on the monitoring intensity and send the indirect regulating instruction to the smart gas device object platform through the gas company sensor network platform to regulate the monitoring parameter of the gas monitoring device corresponding to the affected region.

13. The system of claim 12, wherein the impact estimation model is obtained through training based on a training sample set, and the training sample set includes a plurality of training samples and a label corresponding to each training sample of the plurality of training samples; and
each training sample of the plurality of training samples includes a sample modification map, the label corresponding to each training sample of plurality of training samples is an actual affected degree of the affected region, and the label is determined based on a data variation range of the gas monitoring data and/or a vibration amplitude in a remodeling process, and a count of training samples in the training sample set corresponding to each remodeling manner satisfies a preset count condition.

14. The system of claim 12, wherein the gas company management platform is further configured to:
in response to determining that the monitoring intensity and/or the affected degree satisfy a third monitoring condition, generate a monitoring expansion instruction based on the monitoring intensity and/or the affected degree; and
send the monitoring expansion instruction to the smart gas device object platform via the gas company sensor network platform to control the crawling robot of the smart gas device object platform to move to the affected region and add the gas monitoring device and/or vibration sensors.

15. A non-transitory computer-readable storage medium, wherein the storage medium stores one or more sets of computer instructions, and when a computer reads the one or more sets of computer instructions in the storage medium, the computer implements the method of claim 1.
